(19) United States
(12) Patent Application Publication
(10) Pub. No.: US 2023/0257628 A1
(43) Pub. Date: Aug. 17, 2023

(54) POLYMER EMULSIONS CONTAINING A POLYMERIZED SURFACTANT AND METHODS FOR PRODUCTION AND USE THEREOF

(71) Applicant: MICHELMAN, INC., Cincinnati, OH (US)

(72) Inventor: Wendy GARCIA, Cincinnati, OH (US)

(73) Assignee: MICHELMAN, INC., Cincinnati, OH (US)

(21) Appl. No.: 18/002,916

(22) PCT Filed: Jul. 6, 2021
(86) PCT No.: PCT/US2021/040494

§ 371 Date: Dec. 22, 2022

(30) Foreign Application Priority Data
Jul. 8, 2020 (LU) 101910

(51) Int. Cl. C09D 191/06; C09D 5/02

(52) U.S. Cl. CPC C09D 191/06; C09D 5/027; C09D 5/022

(57) ABSTRACT

Surfactants are commonly employed to prepare aqueous polymer emulsions (latex emulsions) used for forming polymer coatings. Migration of surfactants following polymer coating deposition can be problematic, and poor surface adhesion may occur in some cases. Polymer emulsions leading to improved surface adhesion and other advantageous properties may comprise: an aqueous fluid, a plurality of core particles, a polymer layer formed around at least a majority of the plurality of core particles, and one or more surfactants. The polymer layer comprises a polymer formed from one or more ethylenically unsaturated monomers. The one or more surfactants comprise at least one reactive surfactant having an ethylenic unsaturation that is covalently incorporated within the polymer. The at least one reactive surfactant is absent from the core particles when the polymer layer is formed thereon. The polymer layer is substantially uniform in composition.

### BACKGROUND

Oil-based paints and coating formulations have traditionally been used in many applications due to their organic solvent acting as a plasticizer to aid in polymer film formation. Economic and environmental concerns have shifted the coatings industry increasingly toward water-based coating formulations, such as water-based paints and similar latex dispersions. As used herein, the terms “latex,” “latex emulsion” and “latex dispersion” refer equivalently to an aqueous emulsion comprising polymer particulates. Latex dispersions are often prepared by conducting emulsion polymerization in the presence of one or more surfactants to stabilize the emulsion in situ, although they also may be prepared by emulsifying pre-formed polymer particulates made by other polymerization methods as well. As used herein, the term “surfactant” refers to an amphiphilic molecule that promotes dispersion or emulsification of particles in a fluid medium, particularly an aqueous fluid. The surfactants remain in the latex emulsion once the emulsion polymerization process is complete and typically become incorporated within a water-based coating formed therefrom. In addition to facilitating the initial emulsification, the surfactants may increase the shelf life of water-based coating formulations and promote uniform spreading thereof.

While water-based coating formulations are now widely utilized, there are certain coating features that fail to rival those of their oil-based counterparts. Once a water-based coating has been formed, the surfactant may migrate to the surface, particularly upon exposure of the coating to water, thereby defining a separate phase that may reduce gloss and/or adhesion. The surfactant also may become trapped in pockets, which may increase water sensitivity, possibly accompanied by leaching of the surfactant from the coating and generation of voids. Surface staining and color loss due to surfactant leaching is very common with water-based coatings. Sufficient adhesion of water-based coatings to a wide range of surface types (e.g., wood, glass, plastic, metal and the like) may also be problematic for some water-based coating formulations.

Loss of surface adhesion may allow water to enter between the coating and the substrate, wherein one or more effects in addition to color loss may result. Water may expand the interface at the detached area and promote blistering and/or initiate corrosion. A coating with high residual tensile stress may have a lower adhesion value than one with compressive stress, given the same degree of interfacial interaction. Often, at elevated temperatures during deposition, diffusion may occur at the coating-substrate interface, thereby resulting in intermixing of the coating and substrate materials. Depending on the type of interface formed, significant adhesive strength may result from chemical vapor deposition (CVD) and particle vapor deposition (PVD) coating processes. Liquid-based processes may afford a weaker bond strength in many instances.

### BRIEF DESCRIPTION OF THE DRAWINGS

The following figures are included to illustrate certain aspects of the disclosure, and should not be viewed as exclusive configurations. The subject matter disclosed is capable of considerable modifications, alterations, combinations, and equivalents in form and function, as will occur to those skilled in the art and having the benefit of this disclosure.

FIG. 1A shows a Raman depth measurement of a polymer coating formed from Sample 20 mixed with a wax particle emulsion. FIG. 1B shows a Raman depth measurement of a polymer coating formed from Sample 21.

FIGS. 2A and 2B show images of dry rub resistance testing for illustrative comparative and experimental samples.

### DETAILED DESCRIPTION

The present disclosure generally relates to water-based coatings and coating formulations and, more specifically, polymer emulsions (latex emulsions) prepared in the presence of seed particles and at least one reactive surfactant.

As discussed above, there can be a number of issues associated with water-based coatings formed from latex emulsions, referred to hereinafter as “polymer emulsions.” Among these issues are low gloss and poor surface adhesion. In many instances, these issues arise from surfactant migration that occurs after a coating has been formed upon a surface.

The surfactants commonly used for forming polymer emulsions typically associate at the surface of the polymer particles and do not undergo a chemical reaction to become incorporated within the polymer backbone. Once aqueous solvent has been removed to form a coating, the surfactants have an opportunity to dissociate from the polymer particles and undergo migration, thereby leading to the issues discussed above. Conventional surfactants that are not reacted with a polymer, particularly by incorporation within the polymer backbone, may be referred to equivalently as “migratory surfactants” or “non-reactive surfactants” herein.

The present disclosure demonstrates that by forming a polymer emulsion in the presence of one or more non-migratory surfactants under seeded emulsion polymerization conditions, significantly enhanced coating performance may be realized. As used herein, the term “non-migratory surfactant” refers to a surfactant that may become incorporated within a polymer backbone through undergoing a chemical reaction, particularly when polymerizing one or more monomers during emulsion polymerization in the presence of the non-migratory surfactant. Non-migratory surfactants may replace migratory surfactants when forming a polymer emulsion, or they may be used in combination with migratory surfactants when forming a polymer emulsion. At least a majority of the total surfactants used to form a polymer emulsion may comprise a non-migratory surfactant in order to realize the benefits described herein. Since non-migratory surfactants are non-migratory by virtue of their chemical reactivity and become incorporated within the polymer backbone, such surfactants are referred to hereinafter as “reactive surfactants.”

The benefits of utilizing at least one reactive surfactant during emulsion polymerization may be particularly evident when incorporating a plurality of particles in the emulsion polymerization reaction medium. Suitable particles for use in the present disclosure differ significantly in composition from the polymer being formed and subsequently emulsified. Without being bound by any theory or mechanism, it is believed that the plurality of particles provides nucleation sites (seeds) upon which polymer particulates may form and become emulsified in situ. As polymer particulates form, the seeds remain incorporated as a core particle within at least a majority of the polymer particulates. Unlike many seeded emulsion polymerization processes, the core particles are chosen such that the core particle does not become covalently bonded to the polymer surrounding it. That is, neither the monomers nor the reactive surfactant undergo a reaction with the core particle; instead, there may be a compositional interface between the core particle and the polymer layer surrounding it. The polymer layer itself may be substantially uniform in composition, and once a polymer coating is formed from the polymer emulsion, the polymer coating may be substantially uniform in composition as well. The term “polymer coating” may be used synonymously herein with the terms “film” or “polymer film.” The core particles also may remain uniformly dispersed when formed into the polymer coating, thereby avoiding particle aggregation on the coating surface or within the interior of the coating. Surprisingly, such core particles, when confined in this manner, may enhance the properties of coatings formed from the polymer emulsions. Various core particles may impact the resulting coating properties in different ways, such as improving adhesion and raising contact angle, by way of non-limiting example. Further surprisingly, in some cases, inclusion of the core particles does not overly impact the whitening performance of coatings formed the polymer emulsions. Advantageous properties of coatings formed from the polymer emulsions include, but are not limited to, good to excellent water repellency, corrosion resistance, weathering resistance, oil and grease resistance, dirt pick up repellency, whitening resistance, and excellent adhesion to a wide range of substrates, including glass, paper metal, and wood substrates.

Accordingly, polymer emulsions of the present disclosure may comprise an aqueous fluid, a plurality of core particles, a polymer layer formed around at least a majority of the plurality of core particles, and one or more surfactants, wherein the one or more surfactants comprise at least one reactive surfactant. The polymer layer comprises a polymer formed from one or more ethylenically unsaturated monomers, such that the polymer comprises a substituted polyethylene backbone. The polymer layer may be substantially uniform in composition, as discussed further below. The at least one reactive surfactant has an ethylenic unsaturation that is covalently incorporated within the polymer. The at least one reactive surfactant may become covalently bonded to the polymer in the course of the one or more ethylenically unsaturated monomers undergoing polymerization. The core particle is chosen such that the at least one reactive surfactant is absent from (not covalently bonded to) the core particle when the polymer layer is formed thereon.

Aqueous fluids suitable for use in the present disclosure may comprise water or water admixed with a water-miscible organic solvent, such as an alcohol or a glycol. The aqueous fluids and polymer emulsions may be acidic, neutral, or basic, depending upon particular application needs. A particular pH may be chosen to maintain the emulsion, for example. Buffering may be conducted, if needed or desired. As such, the aqueous fluids and polymer emulsions may have a pH ranging from about 1 to about 7, or about 2 to about 6, or about 1 to about 6, or about 6 to about 7, or about 6 to about 8, or about 7 to about 8, or about 7 to about 14, or about 8 to about 14, or about 8 to about 12, or about 7 to about 9.

Suitable examples of ethylenically unsaturated monomers undergoing a reaction to form the polymer layer are not particularly limited, provided that the resulting polymer particulates having a core particle may be effectively emulsified. Particularly suitable examples may comprise at least one acrylate monomer, more particularly at least one acrylate ester. The term “acrylate monomer” refers to a monomer selected from acrylic acid, methacrylic acid, an acrylic acid ester, a methacrylic acid ester, any derivative thereof, or any combination thereof, Derivative forms of the foregoing include, for example, acrylamides, methacrylarnides, amine-functionalized (meth)acrylate monomers, polyether-functionalized (meth)acrylate monomers, and the like. Specific examples of suitable acrylate monomers may include, for example, n-butyl (meth)acrylate, isobutyl (meth)acrylate, methyl (meth)acrylate, ethyl (meth)acrylate, 2-ethylhexyl (meth)acrylate, and cycloalkyl (meth)acrylates such as isobornyl (meth)acrylate and cyclohexyl (meth)acrylate, and (meth)acrylamide. Other suitable acrylate monomers may include, for example, hydroxy-functionalized acrylate monomers such as hydroxyethyl (meth)acrylate and hydroxylpropyl (meth)acrylate; (meth)acrylamide derivatives such as N-methylol (meth)acrylamide and diacetone (meth)acrylamide; diallyl (meth)acrylate and various alkylene glycol di(meth)acrylates.

Other suitable ethylenically unsaturated monomers may comprise at least one amine group, such as a primary amine, a second amine or a tertiary amine. Particularly suitable examples of ethylenically unsaturated monomers comprising at least one amine group include acrylate monomers such as, for example, 2-(dimethylamino)ethyl (meth)acrylate, 3-(dimethylamino)propyl (meth)acrylate, 2-(diethylamino)ethyl (meth)acrylate, 3-(diethylamino)propyl (meth)acrylate, 2-(ethylamino)ethyl (meth)acrylate, 3-(ethylamino)propyl (meth)acrylate, 2-(methylamino)ethyl (meth)acrylate, 3-(methylamino)propyl (meth)acrylate, 2-(tert-butylamino)ethyl (meth)acrylate, 3-(tert-butylamino)propyl (meth)acrylate, 2-(dimethylamino)ethyl (meth)acrylamide, 3-(dimethylamino)propyl (meth)acrylamide, 2-(diethylamino)ethyl (meth)acrylamide, 3-(dimethylamino)propyl (meth)acrylamide, 2-(methylamino)ethyl (meth)acrylamide, 3-(methylamino)propyl (meth)acrylamide, 2-(ethylamino)ethyl (meth)acrylamide, 3-(ethylamino)propyl (meth)acrylamide, 2-(tert-butylamino)ethyl (meth)acrylamide, and 3-(tert-butylamino)propyl (meth)acrylamide. Vinyl amine may also represent a suitable monomer in some cases.

Alpha olefins are another type of ethylenically unsaturated monomer that may be present in the polymers, any of which may be copolymerized with at least one acrylate monomer, such as those provided above. Suitable alpha olefins that the may be present in the polymers formed in accordance with the present disclosure include, but are not limited to, ethylene, propylene, isobutylene, 1-butene, 1-pentene, 1-hexene, 4-methyl-1-pentene, 1-octene, 1-decene, 1-dodecene, 1-tetradecene, or any combination thereof. Linear alpha olefins having an even number of carbon atoms may be particularly suitable due to their ready commercial availability.

Still other examples of ethylenically unsaturated monomers that may be present in the polymers include, for example, styrene or substituted variants thereof; divinyl benzenes; dienes such as 1,3-butadiene and isoprene; vinyl esters, such as vinyl acetate, vinyl alkanoates or their derivatives; nitriles such as (meth)acrylonitrile and fumaronitrile; (meth)acrylamides; ethylenically unsaturated halides such as vinyl chloride and vinylidene chloride, any of which may be present in combination with at least one acrylate monomer and/or at least one alpha olefin.

Ethylenically unsaturated monomers bearing at least one acidic group may also be present, such as those bearing a side chain carboxylic acid or sulfonic acid. Illustrative examples may include, but are not limited to, maleic acid, methyl hydrogen maleate, ethyl hydrogen maleate, itaconic acid, fumaric acid, crotonic acid, citraconic acid, styrenesulfonic acid, and 2-aminomethylpropanesulfonic acid derivatized with a vinyl group. Carboxylic acid forms of the foregoing monomers may be present in an esterified form as well, such as methyl, ethyl, propyl, isopropyl, butyl, isobutyl, t-butyl or like esterified form. Other suitable esterified monomers may comprise an ethylenically unsaturated group in the alcohol-derived portion of the esterified monomer. Such ethylenically unsaturated monomers may include, for example, vinyl acetate, allyl acetate, vinyl propionate, allyl propionate, vinyl benzoate, allyl benzoate, and the like.

The one or more ethylenically unsaturated monomers may be optionally crosslinked in the polymer layer. Thus, in some embodiments, the polymer may be substantially non-crosslinked within the polymer layer, and in other embodiments, the polymer may be crosslinked within the polymer layer. Crosslinking, when present, may take place during the polymerization reaction forming the polymer layer, or crosslinking may take place afterward in a separate crosslinking step distinct from the main polymerization reaction forming the polymer layer. Diene monomers, for example, may undergo crosslinking during the initial polymerization reaction. Ethylenically unsaturated monomers bearing particular heteroatom functionality may undergo crosslinking during the initial polymerization reaction or during a separate crosslinking step to react latent crosslinkable groups. Suitable crosslinkable monomers bearing a heteroatom functionality and an ethylenic unsaturation may include, but are not limited to, methyl vinyl ketone, ethyl vinyl ketone, butyl vinyl ketone, acrolein, methacrolein, crotonaldehyde, diacetonacrylamide (DAAM), diacetone methacrylamide, diacetone (meth)acrylates, acetoacetoxyethyl methacrylate (AAEM), glycidyl (meth)acrylate, and any combination thereof. A crosslinking agent that is not ethylenically unsaturated may be present to promote crosslinking, if the monomer itself is incapable of undergoing self-crosslinking. Thus, even polymers containing one or more latent crosslinkable groups may remain substantially non-crosslinked until a suitable crosslinking agent is present. Suitable crosslinking agents for the ethylenically unsaturated monomers disclosed herein will be familiar to one having ordinary skill in the art.

In some embodiments, the polymer may contain crosslinkable monomers but remain substantially non-crosslinked when present as the polymer layer upon the core particles. After the polymer emulsion has been deposited to form a polymer coating upon a surface, the polymer may remain substantially non-crosslinked, or become at least partially crosslinked upon the surface. Crosslinking upon a surface may again occur through self-crosslinking or through addition of a suitable crosslinking agent when depositing the polymer emulsion upon the surface.

The polymers of the present disclosure may have properties tailored for particular coating applications, wherein tailoring may be realized by varying the monomers and amounts thereof undergoing polymerization. Crosslinkable monomers within the polymer and/or crosslinking agents within the polymer emulsions may also alter the coating properties. Additional tailoring of the coating properties may be realized by varying the core particles used therewith, as discussed hereinafter. Polymer properties that may be varied include, for example, hydrophobicity/hydrophilicity, molecular weight, glass transition temperature and the like. Particularly suitable polymers of the present disclosure may have a glass transition temperature ranging from about 5° C. to about 50° C. Glass transition temperatures in this range may afford good film formation properties, in a non-limiting example. If the glass transition temperature is too low, excessive tackiness may result. Glass transition temperatures may be determined by differential scanning calorimetry (DSC) at a heating rate of 40° C./min up to a temperature of 130° C. Depending on the polymerization conditions and other factors, the polymer molecular weights (Mw) may range from about 1×10³ to about 1×10⁷, or about 1×10⁴ to about 1×10⁷, or about 1×10⁴ to about 1×10⁶, or about 1×10⁵ to about 1×10⁶. Molecular weights (as Mw-weight average molecular weight) are measured by gel-permeation chromatograph (GPC) using THF as a mobile phase and against polystyrene standards. Even higher molecular weights may be realized when crosslinking occurs. It is to be appreciated that polymer molecular weights outside the foregoing ranges also may be suitable for use in the disclosure herein.

The at least one reactive surfactant may comprise an ethylenic unsaturation that undergoes polymerization with one or more ethylenically unsaturated monomers, as specified above. The ethylenic unsaturation may be present in a reactive surfactant that is an anionic surfactant, a cationic surfactant, a zwitterionic surfactant, a neutral surfactant, or any combination thereof. Particularly suitable reactive surfactants may comprise an anionic surfactant. Suitable anionic surfactants may comprise a phosphate, carboxylate, sulfate or sulfonate as a hydrophilic head group. Phosphate and sulfate surfactants may be especially useful for promoting good coating properties in the disclosure herein.

Suitable reactive surfactants that are anionic may include, but are not limited to, those comprising a modified (meth)acrylate, vinylbenzene or substituted vinylbenzene, or maleate scaffold having a phosphate, sulfonate, sulfate or carboxylate as a hydrophilic head group. Suitable reactive surfactants may also include a hydrocarbyl moiety appended to the scaffold that is not directly reactive with the one or more ethylenically unsaturated monomers. Suitable hydrocarbyl groups may include, for example, C1-C100 alkyl groups, or C4-50 alkyl groups, or C8-C30 alkyl groups, which may be straight chain or branched. Particularly suitable examples of reactive surfactants comprising a phosphate group may include, but are not limited to, SIPOMER PAM 100, 200, 600 or 4000 (BASF) and the like, MAXEMUL 6106 or 6112 (Croda) and the like, and REASOAP PP-70 (Adeka) and the like. Suitable examples of reactive surfactants comprising a sulfate group may include, for example, HITENOL surfactants (Montello) and the like.

Still other examples of suitable reactive surfactants that may be used in any embodiment herein include, but are not limited to, those comprising a hydrophilic head group selected from a sulfonate group, a sulfate group, a quaternary phosphonium group, a quaternary ammonium group, a pyridinium group, an isothiouronium group and the like, and a polymerizable group, particularly an ethylenic unsaturation. The reactive surfactants may further comprise a hydrocarbyl moiety, as specified above. Particular examples of such reactive surfactants may include, but are not limited to, 2-sulfoethyl (meth)acrylate, sodium vinylsulfonate, 2-hydroxy-3-sulfopropyl (meth)acrylate, 2-acrylamido-2-methylpropanesulfonic acid, sodium styrenesulfonate, vinyl-substituted quaternary ammonium salts such as N,N,N-trimethyl-N-(meth)acryloxyethyl ammonium chloride, N,N,N-trimethyl-N-(meth)acryloxy(2-hydroxypropyl)ammonium chloride, vinylbenzyldialkyl sulfonium salts such as dimethyl vinylbenzylsulfonium chloride, and the like.

In addition to the at least one reactive surfactant, the one or more surfactants may further comprise one or more non-reactive surfactants that do not become incorporated within the polymer backbone, such as through reaction of an ethylenic unsaturation. Although “non-reactive” as defined herein, non-reactive surfactants may passively promote emulsification by virtue of their chemical structure. Furthermore, “non-reactive” surfactants are not limited from undergoing other types of chemical reactions that do not lead to incorporation of the non-reactive surfactant into the polymer backbone. Suitable non-reactive surfactants may be cationic, anionic, zwitterionic, non-ionic, or any combination thereof. Illustrative non-reactive surfactants that may be suitable for use in combination with one or more reactive surfactants include, but are not limited to, non-ionic surfactants such as alkylaryl polyether alcohols, alkylphenol ethoxylates, alkyl ethoxylates, polyoxamers, fatty acid esters (e.g., fatty acid glycerol esters, fatty acid sorbitan esters, fatty acid sorbitol esters, fatty acid lecithin esters, and the like), polyethylene oxide sorbitan fatty acid esters, and any combination thereof. Polymer colloids such as polyvinyl alcohol, polyvinylpyrrolidone, hydroxyethylcellulose and other cellulose derivatives, and the like may also comprise suitable non-ionic surfactants that are non-reactive. Illustrative non-reactive anionic surfactants that may be suitable for use in the disclosure herein include, but are not limited to, alkyl ethoxylate sulfates, alkyl ethoxylate sulfonates, alkylphenol ethoxylate sulfates, alkylphenol ethoxylate sulfonates, alkylsulfates, alkylsulfonates, alkylarylsulfates, alkylarylsulfonates, sulfosuccinates, and any combination thereof, optionally in further combination with at least one non-reactive surfactant that is classified as non-ionic. Carboxylate salts of long-chain fatty acids such as dodecanoic acid, stearic acid, oleic acid, palmitic acid, and the like may also be suitably used as a non-reactive anionic surfactant in the disclosure herein. Phosphate esters of long-chain fatty alcohols may similarly be used as a non-reactive anionic surfactant in any embodiment of the disclosure herein. Illustrative zwitterionic surfactants that may be suitable for use in the disclosure herein include various betaines and sultaines. Particularly suitable non-reactive surfactants for use in the disclosure herein may include, but are not limited to, those sold under the tradename DISPONIL® (BASF, non-ionic surfactant) and those sold under the tradename AEROSOL® (Solvay, anionic surfactant).

In some embodiments, a cationic non-reactive surfactant may be present in combination with the at least one reactive surfactant. In some embodiments, an anionic non-reactive surfactant may be present in combination with the at least one reactive surfactant. In some embodiments, a zwitterionic non-reactive surfactant may be present in combination with the at least one reactive surfactant. In some embodiments, a neutral non-reactive surfactant may be present in combination with the at least one reactive surfactant. In any of the foregoing, the at least one reactive surfactant may be an anionic surfactant, including any of the anionic reactive surfactants disclosed above.

The one or more surfactants may be present in the polymer emulsions of the present disclosure in an amount ranging from about 0.2 wt. % to about 10 wt. %, or about 0.2 wt. % to about 7 wt. %, as measured based on total solids. As discussed above, the one or more surfactants may comprise at least one reactive surfactant and, optionally, at least one non-reactive surfactant. The at least one reactive surfactant may be present in a greater amount than the at least one non-reactive surfactant in particularly suitable configurations of the present disclosure. That is, the at least one reactive surfactant may comprise a majority of the one or more surfactants, as measured on a weight basis. Suitable amounts of the at least one reactive surfactant may range from about 0.2 wt. % to about 5 wt. % or about 0.5 wt. % to about 3 wt. %, as measured based on total solids. When present, each non-reactive surfactant may be present in a non-zero amount up to about 2.0 wt. %, a non-zero amount up to about 1.0 wt. %, or a non-zero amount up to about 0.5 wt. %, or a non-zero amount up to about 0.1 wt. %, each as measured based on total solids. When multiple non-reactive surfactants are used, the individual non-reactive surfactants may be present in substantially equal amounts or in different amounts. Even when multiple non-reactive surfactants are present, the at least one reactive surfactant may still comprise a majority of the one or more surfactants, based on a total mass of surfactants that are present.

The core particles used in the present disclosure may comprise any hydrophobic substance that is non-reactive with the at least one reactive surfactant and the ethylenically unsaturated monomers undergoing a reaction to form the polymer layer. Suitable core particles also may be chosen for their ability to be successfully emulsified and, when emulsified, to serve as a nucleation seed for facilitating growth of a polymer layer around the core particles. Illustrative core particles that may be suitable for use in the disclosure herein include, for example, silicone elastomers, polymers that are unreactive with the at least one reactive surfactant and the ethylenically unsaturated monomers, and waxes, particularly paraffinic waxes, examples of which are provided hereinbelow. Inorganic salts that are insoluble in water may also be suitably used. Particularly suitable core particles may have a melting point of about 50° C. or above and an average diameter of about 100 nm or less, preferably an average diameter ranging from about 10 nm to about 100 nm, or about 25 nm to about 50 nm, or about 50 nm to about 90 nm, or about 20 nm to about 75 nm. If the core particle size is too large or too small, lack of emulsion particle size control may result. For example, if the core particles are too large, some emulsified polymer particles may not be formed around a core particle, thereby leading to loss of size control.

Waxes are hydrophobic organic substances that occur in petroleum or other oleaginous materials, are biosynthesized by plants and animals, or are obtained synthetically. Waxes are usually malleable solids at room temperature and may comprise one or more higher alkanes (paraffins), particularly normal or branched C16-Cioo alkanes or C20-50 alkanes, lipids and/or oils. Suitable waxes for use as core particles in the disclosure herein may include, but are not limited to, paraffin waxes, oxidized paraffin waxes, polyolefin waxes, oxidized polyolefin waxes, natural waxes, oxidized natural waxes, and any combination thereof. As used herein, a wax is considered “oxidized” if oxygenated functional groups such as alcohols, carboxylic acids, epoxides or the like are introduced to an otherwise unsubstituted (paraffinic) polymer backbone following polymer or oligomer synthesis. The amount of oxygenated functional groups introduced to a particular wax may, for example, be sufficient to lower the hydrophobicity of the wax to an extent necessary to facilitate formation of an emulsified form of the wax. Particularly suitable waxes for use in the disclosure herein may comprise paraffin waxes and lipidic waxes, either of which may be oxidized or partially oxidized, and none of which are reactive with ethylenically unsaturated monomers or reactive surfactants having an ethylenic unsaturation.

Suitable paraffin waxes and lipidic waxes for use in the disclosure herein may include, but are not limited to, slack wax, beeswax, hydrogenated lipids, refined wax, semi-refined wax, scale wax, microcrystalline wax, beeswax, vegetable-based waxes such as soy and palm waxes, carnauba wax, rice bran wax, synthetic waxes such as oligomer waxes derived from linear alpha olefins, Fischer-Tropsch waxes, polyolefin waxes (e.g., polyethylene wax or polypropylene wax), and any combination thereof. Examples of suitable wax emulsions that may be used in the disclosure herein to provide core particles for emulsion polymerization include, but are not limited to, MICHEM® emulsions such as ME62330, ME93335, ME61335, ME52137, and ME24414 (Michelman, Inc.).

The core particles, such as one or more waxes, may be present in the polymer emulsions described herein in an amount up to about 30 wt. %, or up to about 10 wt. %, such as about 1 wt. % to about 10 wt. %, each as measured based on total solids.

Still other additives may be present in the polymer emulsions disclosed herein such as, for example, pigments, dyes, optical brighteners, crosslinkers, defoamers, anti-static agents, dispersants, thickeners, fillers, biocides, rheology modifiers, preservatives, coalescent aids, other emulsified polymers, buffers, biocides, co-solvents, and any combination thereof.

Advantageously, the polymer layer formed around the core particles according to the disclosure herein may be readily prepared using emulsion polymerization, as discussed in further detail below. That is, the polymer layer and the polymer emulsion may be formed directly by emulsion polymerization of a reaction mixture containing at least the aqueous fluid, the plurality of core particles, the one or more ethylenically unsaturated monomers, and the one or more surfactants comprising the at least one reactive surfactant. When formed by emulsion polymerization, the polymer layer may be compositionally uniform, such that the monomer content of the polymer layer (including reactive surfactant(s) co-polymerized with the one or more ethylenically unsaturated monomers) does not change substantially between the surface of the core particles and an outer surface of the emulsified particles. Such polymer layers may be formed through single-stage emulsion polymerization using a set ratio of the one or more ethylenically unsaturated monomers and the at least one reactive surfactant. The polymer layer may further comprise the at least one non-reactive surfactant, if present, wherein the at least one non-reactive surfactant is incorporated within the polymer layer but not covalently bonded thereto. Other polymerization techniques applicable for forming the polymer layer in the disclosure herein may include, for example, bulk polymerization or solution polymerization, followed by disposition of the polymer layer upon the core particles and emulsification thereof. Polymer layers formed in these alternative manners may also be compositionally uniform. In any polymerization technique, polymerization may be initiated with a suitable radical initiator, illustrative examples of which are provided hereinbelow.

Methods for forming the polymer emulsions of the present disclosure are also contemplated herein. Suitable methods for forming the polymer emulsions may employ emulsion polymerization techniques to form the polymer layer around the core particles. Any of the polymer emulsions formulated as above may be prepared through emulsion polymerization in accordance with the methods disclosed herein. The methods may comprise: providing a core particle emulsion comprising a first aqueous fluid, a plurality of core particles, and a first surfactant; combining one or more ethylenically unsaturated monomers and at least one reactive surfactant having an ethylenic unsaturation with the core particle emulsion to form a combined emulsion; and polymerizing the one or more ethylenically unsaturated monomers and the at least one reactive surfactant to form a polymer emulsion comprising a plurality of emulsified particles comprising a polymer layer formed around at least a majority of the plurality of core particle, the at least one reactive surfactant being covalently incorporated within the polymer; wherein the at least one reactive surfactant is absent from the core particles when the polymer layer is formed thereon. The polymer layer may be substantially uniform in composition. Optionally, a polymer comprising the polymer layer may be substantially non-crosslinked when present upon the core particles. In particularly suitable process configurations, polymerizing the one or more ethylenically unsaturated monomers and the at least one reactive surfactant may take place through free radical polymerization.

The one or more ethylenically unsaturated monomers and/or the at least one reactive surfactant may be combined directly into the core particle emulsion, either neat or as an aqueous solution or emulsion. More desirably, the one or more ethylenically unsaturated monomers and the at least one reactive surfactant may be present in a monomer emulsion comprising a second aqueous fluid that is combined with the core particle emulsion. The first aqueous fluid and the second aqueous fluid may be the same or different, but may be typically the same type of aqueous fluid. Either or both of the core particle emulsion and the monomer emulsion may comprise a non-reactive surfactant and/or pH adjuster (e.g., acid, base, buffer, or the like) as needed to stabilize the emulsion present therein.

In the combined emulsion, the core particles may be present in an amount up to about 30 wt. % or up to about 10 wt. %, and the at least one surfactant may be present in an amount ranging from about 0.2 wt. % to about 10 wt. % or about 0.2 wt. % to about 7 wt. %, each as measured based upon total solids. The at least one reactive surfactant may be present in the combined emulsion in an amount ranging from about 0.2 wt. % to about 5 wt. % or about 0.7 wt. % to about 3 wt. %, each as measured based upon total solids.

A radical initiator may be present in the combined emulsion in an amount sufficient to promote a polymerization reaction of the one or more ethylenically unsaturated monomers. Suitable radical initiators may be capable of promoting radical polymerization under thermal conditions. That is, polymerization may take place thermally in the presence of a first radical initiator. Such radical initiators may include, but are not limited to, sodium persulfate or other alkali metal persulfates, ammonium persulfate, azo compounds (e.g., 4,4′-azobis-cyanovaleric acid and/or AIBN), redox systems comprising sodium hydroxymethane sulfonate (sodium formaldehyde sulfoxylate) and reducing agents such as ascorbic acid, oxidizing initiators such as t-butyl-hydroperoxide, the like, and any combination thereof. The polymerization reaction to form the polymer layer in the presence of the first radical initiator may occur at a temperature ranging from about 20° C. to about 90° C. Organic chain transfer agents, also known as regulators, such as 2-mercaptoethanol and tert-dodecylmercaptan, among others familiar to persons having ordinary skill in the art, can also be employed to control the molecular weight of the polymer forming the polymer layer.

Optionally, after forming the polymer layer, additional polymerization may be conducted, particularly under reductive conditions in the presence of a second radical initiator. The second radical initiator may be the same as or different than the first radical initiator used to promote formation of the polymer layer. Suitable second radical initiators may include, for example, azo compounds such as 4,4′-azobis-cyanovaleric acid or AIBN, organic hydroperoxides such as t-butyl hydroperoxide, redox systems comprising sodium hydroxymethane sulfonate and ascorbic acid, or any combination thereof. In non-limiting examples, the additional polymerization may aid in substantially ridding the polymer emulsion of residual monomers, particularly under non-thermal conditions. Preferably, additional polymerization may be conducted under reductive conditions. Crosslinking may also result during the additional polymerization in some instances. Optionally, crosslinking, if performed, may instead occur after depositing the polymer emulsion and forming a polymer coating upon the surface of a base substrate. Deposition upon a base substrate is addressed in further detail hereinafter.

After formation of the polymer emulsion in accordance with the disclosure above, methods of the present disclosure may further comprise disposing the polymer emulsion upon a base substrate, and evaporating aqueous fluid from the polymer emulsion while upon the base substrate to form a polymer coating disposed upon a surface of the base substrate. Optionally, crosslinking of the polymer within the polymer coating may occur in the course of forming the polymer coating upon the base substrate. Application of the polymer emulsion to the base substrate may be achieved using any of a variety of methods such as, for example, immersion, spraying, rod or roller coating, or through using equipment such as a size press, water box, blade coater, cast coater, rod coater, air knife coater, curtain coater, film press coater, flexo coater, or the like. The polymer emulsion may be applied inline during a continuous coating process integrated with formation of the polymer emulsion, or the coating may be formed in a processing line separate from formation of the polymer emulsion. The coated substrate may be further processed, if desired, in either case.

Accordingly, coated substrates formed from the polymer emulsions of the present disclosure are also contemplated herein. The coated substrates may comprise a base substrate, and a polymer coating disposed upon a surface of the base substrate, wherein the polymer coating is formed from any of the polymer emulsions disclosed herein. Choice of a particular polymer emulsion used to form a given coating may be dictated by various application-specific needs. Formation of the polymer coating upon the base substrate may be conducted by providing any of the polymer emulsions disclosed herein, disposing the polymer emulsion upon a base substrate, and evaporating aqueous fluid from the polymer emulsion while upon the base substrate to form the polymer coating disposed upon the surface of the base substrate. The polymer may be crosslinked or substantially non-crosslinked within the polymer coating upon the base substrate. The core particles may remain distributed substantially uniformly throughout the polymer coating.

Accordingly, coated substrates may be prepared by a process comprising: providing a polymer emulsion of the present disclosure; disposing the polymer emulsion upon the surface of the base substrate; and evaporating aqueous fluid from the polymer emulsion while upon the base substrate to form the polymer coating. Heating and/or application of vacuum may take place in some instances to promote more rapid evaporation of the aqueous fluid. Evaporation of the aqueous fluid from the polymer emulsion may take place with sufficient rapidity under atmospheric pressure in many instances, but optionally make take place under a vacuum or partial vacuum if a faster rate of aqueous solvent removal is needed. The temperature and/or pressure at which evaporation is conducted may influence the coating properties in some instances. The polymer within the polymer coating may become crosslinked or remain substantially non-crosslinked, in various embodiments.

Base substrates that may be coated with a polymer coating of the present disclosure are not considered to be particularly limited. Illustrative base substrates that may be coated according to the present disclosure include, for example, wood, paper, metal, concrete, glass, polymers, or any combination thereof.

Coating thicknesses of the polymer coatings formed according to the present disclosure may range from about 10 μm to about 400 μm, or about 50 μm to about 300 μm, or about 75 μm to about 225 μm. Coating thicknesses may be selected based on their suitability for a given application. By way of non-limiting example, thicker coatings may be more applicable for conveying corrosion resistance, such as coating thicknesses of about 100 μm or greater or about 200 μm or greater. Thinner coatings, in contrast, may be more applicable for water and grease barrier applications, such as upon paper substrates.

Embodiments disclosed herein include:

A. Polymer emulsions. The polymer emulsions comprise: an aqueous fluid; a plurality of core particles; a polymer layer formed around at least a majority of the plurality of core particles, the polymer layer comprising a polymer formed from one or more ethylenically unsaturated monomers; wherein the polymer layer is substantially uniform in composition; and one or more surfactants; wherein the one or more surfactants comprise at least one reactive surfactant having an ethylenic unsaturation that is covalently incorporated within the polymer; and wherein the at least one reactive surfactant is absent from the core particles when the polymer layer is formed thereon.

A1. Polymer emulsions. The polymer emulsions comprise: an aqueous fluid; a plurality of core particles; a polymer layer formed around at least a majority of the plurality of core particles, the polymer layer comprising a polymer formed from one or more ethylenically unsaturated monomers; and one or more surfactants; wherein the one or more surfactants comprise at least one reactive surfactant having an ethylenic unsaturation that is covalently incorporated within the polymer; and wherein the at least one reactive surfactant is absent from the core particles when the polymer layer is formed thereon.

B. Coated substrates. The coated substrates comprise: a base substrate; and a polymer coating disposed upon a surface of the base substrate, the polymer coating being formed from the polymer emulsion of embodiment A. Optionally, the polymer may be crosslinked within the polymer coating.

C. Methods for making a polymer emulsion. The methods comprise: providing a core particle emulsion comprising a first aqueous fluid, a plurality of core particles, and a first surfactant; combining one or more ethylenically unsaturated monomers and at least one reactive surfactant having an ethylenic unsaturation with the core particle emulsion to form a combined emulsion; and polymerizing the one or more ethylenically unsaturated monomers and the at least one reactive surfactant to form a polymer emulsion comprising a plurality of emulsified particles comprising a polymer layer formed around at least a majority of the plurality of core particles, the at least one reactive surfactant being covalently incorporated within a polymer comprising the polymer layer; wherein the polymer layer is substantially uniform in composition and the at least one reactive surfactant is absent from the core particles when the polymer layer is formed thereon.

C1. Methods for making a polymer emulsion. The methods comprise: providing a core particle emulsion comprising a first aqueous fluid, a plurality of core particles, and a first surfactant; combining one or more ethylenically unsaturated monomers and at least one reactive surfactant having an ethylenic unsaturation with the core particle emulsion to form a combined emulsion; and polymerizing the one or more ethylenically unsaturated monomers and the at least one reactive surfactant to form a polymer emulsion comprising a plurality of emulsified particles comprising a polymer layer formed around at least a majority of the plurality of core particles, the at least one reactive surfactant being covalently incorporated within a polymer comprising the polymer layer; wherein the at least one reactive surfactant is absent from the core particles when the polymer layer is formed thereon.

Each of embodiments A, A1, B, C and C1 may have one or more of the following additional elements in any combination:

Element 1: wherein the at least one reactive surfactant comprises an anionic surfactant.

Element 2: wherein the at least one reactive surfactant comprises a phosphate or a sulfate.

Element 3: wherein the plurality of core particles comprises wax particles.

Element 4: wherein the wax particles comprise at least one wax selected from the group consisting of a paraffin wax, an oxidized paraffin wax, a polyolefin wax, an oxidized polyolefin wax, a natural wax, an oxidized natural wax, and any combination thereof.

Element 5: wherein the plurality of core particles have an average diameter about 100 nm or less.

Element 6: wherein the polymer comprises at least one acrylate monomer.

Element 7: wherein the one or more surfactants further comprise at least one non-reactive surfactant.

Element 7A: wherein the at least one reactive surfactant comprises a majority of the one or more surfactants on a weight basis.

Element 7B: wherein the one or more surfactants comprise at least one neutral surfactant.

Element 8: wherein the core particles are present in an amount ranging from about 1 wt. % to about 30 wt. %, as measured based on total solids.

Element 9: wherein the one or more surfactants are present in an amount ranging from about 0.2 wt. % to about 7.0 wt. %, as measured based on total solids.

Element 10: wherein the polymer is substantially non-crosslinked within the polymer layer.

Element 11: wherein the at least one reactive surfactant is present in an amount ranging from about 0.2 wt. % to about 5 wt. %, as measured based on total solids.

Element 12: wherein the base substrate comprises a material selected from the group consisting of wood, paper, metal, concrete, glass, polymer, and any combination thereof.

Element 13: wherein the polymer coating is disposed upon the base substrate by a process comprising: providing the polymer emulsion; disposing the polymer emulsion upon the surface of the base substrate; and evaporating aqueous fluid from the polymer emulsion while upon the base substrate to form the polymer coating.

Element 14: wherein the one or more ethylenically unsaturated monomers and the at least one reactive surfactant are present in a monomer emulsion comprising a second aqueous fluid that is combined with the core particle emulsion.

Element 15: wherein the first aqueous fluid and the second aqueous fluid are the same.

Element 16: wherein polymerizing takes place thermally in the presence of a first radical initiator.

Element 17: wherein the method further comprises conducting further polymerization under reductive conditions.

Element 18: wherein the method further comprises disposing the polymer emulsion upon a base substrate; and evaporating aqueous fluid from the polymer emulsion while upon the base substrate to form a polymer coating disposed upon a surface of the base substrate.

Element 19: wherein the method further comprises crosslinking the polymer within the polymer coating.

Element 19A: wherein the polymer is crosslinked within the polymer coating.

Element 20: wherein the plurality of core particles are uniformly dispersed within the polymer coating.

By way of non-limiting example, exemplary combinations applicable to A, A1, B, C and C1 include, but are not limited to, 1 and 2; 1 and 3; 1-3; 1 and 4; 2 and 4; 1, 3 and 4; 2-4; 1 and 5; 2 and 5; 3 and 5; 1 and 6; 2 and 6; 3 and 6; 1 and 7, 7A, and/or 7B; 2 and 7, 7A, and/or 7B; 3 and 7, 7A, and/or 7B; 1 and 8; 2 and 8; 3 and 8; 1 and 9; 2 and 9; 3 and 9; 1 and 10; 2 and 10; 3 and 10; 1 and 11; 2 and 11; 3 and 11; 1, 8 and 9; 1, 2 or 3, and 8 and 9; 1, 2 or 3, and 8 and 10; 1, 2 or 3, and 8 and 11; 1, 2 or 3, and 9 and 10; 1, 2 or 3, and 9 and 11; 1, 2 or 3, and 10 and 11; 5 and 6; 5 and 7, 7A, and/or 7B; 5 and 8; 5 and 9; 5 and 10; 5 and 11; 6 and 7, 7A, and/or 7B; 6 and 8; 6 and 9; 6 and 10; 6 and 11; 7, 7A, and/or 7B, and 8; 7, 7A, and/or 7B, and 9; 7, 7A, and/or 7B, and 10; 7, 7A, and/or 7B, and 11; 8 and 9; 8 and 10; 8 and 11; 9 and 10; 9 and 11; 10 and 11; 8-10; 8-11; 9-11; and 8, 10 and 11. Additional non-limiting exemplary combinations applicable to B include any of the foregoing in further combination with 12 or 19A. Still other non-limiting exemplary combinations applicable to B include, but are not limited to, 1 and 12; 2 and 12; 3 and 12; 3, 4 and 12; 5 and 12; 6 and 12; 7, 7A, and/or 7B, and 12; 8 and 12; 9 and 12; 10 and 12; 11 and 12; 1 and 13; 2 and 13; 3 and 13; 3, 4 and 13; 5 and 13; 6 and 13; 7, 7A, and/or 7B, and 13; 8 and 13; 9 and 13; 10 and 13; 12 and 13; 1, 13, and 19A; 2, 13, and 19A; 3, 13, and 19A; 3, 4, 13, and 19A; 5, 13, and 19A; 6, 13, and 19A; 7, 7A, and/or 7B, 13, and 19A; 8, 13, and 19A; 9, 13, and 19A; 10, 13, and 19A; 12, 13, and 19A; 1 and 19A; 2 and 19A; 3 and 19A; 3, 4, and 19A; 5 and 19A; 6 and 19A; 7, 7A, and/or 7B, and 19A; 8 and 19A; 9 and 19A; 10 and 19A; and 12 and 19A. Additional non-limiting exemplary combinations applicable to C and C1 include any of the foregoing in further combination with one or more of 14-18. Still other non-limiting exemplary combinations applicable to C and C1 include, but are not limited to, 1 and 14; 2 and 14; 3 and 14; 3, 4 and 14; 5 and 14; 6 and 14; 7, 7A, and/or 7B, and 14; 8 and 14; 9 and 14; 10 and 14; 11 and 14; 1 and 15; 2 and 15; 3 and 15; 3, 4 and 15; 5 and 15; 6 and 15; 7,7A, and/or 7B, and 15; 8 and 15; 9 and 15; 10 and 15; 11 and 15; 1 and 16; 2 and 16; 3 and 16; 3, 4 and 16; 5 and 16; 6 and 16; 7, 7A, and/or 7B, and 16; 8 and 16; 9 and 16; 10 and 16; 11 and 16; 1, and 16 and 17; 2, and 16 and 17; 3, and 16 and 17; 3, 4, and 16 and 17; 5, and 16 and 17; 6, and 16 and 17; 7, 7A, and/or 7B, and 16 and 17; 8, and 16 and 17; 9, and 16 and 17; 10, and 16 and 17; 11, and 16 and 17; 1 and 18; 2 and 18; 3 and 18; 3, 4 and 18; 5 and 18; 6 and 18; 7, 7A, and/or 7B, and 18; 8 and 18; 9 and 18; 10 and 18; 11 and 18; 1, and 12 and 18; 2, and 12 and 18; 3, and 12 and 18; 3, 4, and 12 and 18; 5, and 12 and 18; 6, and 12 and 18; 7, 7A, and/or 7B, and 12 and 18; 8, and 12 and 18; 9, and 12 and 18; 10, and 12 and 18; 11, and 12 and 18; 14 and 15; 14 and 16; 14, 16 and 17; 14 and 18; 15 and 16; 15-17; 15 and 18; 16 and 18; 16-18; 1 and 19; 2 and 19; 3 and 19; 3, 4 and 19; 5 and 19; 6 and 19; 7, 7A, and/or 7B, and 19; 8 and 19; 9 and 19; 11 and 19; 1, and 12 and 19; 2, and 12 and 19; 3, and 12 and 19; 3, 4, and 12 and 19; 5, and 12 and 19; 6, and 12 and 19; 7, 7A, and/or 7B, and 12 and 19; 8, and 12 and 19; 9, and 12 and 19; 11, and 12 and 19; 14 and 19; 15 and 19; 16 and 19; 17 and 19; and 18 and 19.

To facilitate a better understanding of the disclosure herein, the following examples of various representative embodiments are given. In no way should the following examples be read to limit, or to define, the scope of the present disclosure.

### EXAMPLES

General Conditions for Polymer Emulsion Formation in the Presence of Wax Particles. One kilogram of product was prepared by semi-batch emulsion polymerization in a temperature-regulated, double-walled glass reactor, fitted with an overhead condenser, stirrer and nitrogen inlet. The glass reactor was charged with 76.7 g MICHEM 62330 wax emulsion (Michelman, an anionic paraffin/polyethylene co-emulsion) and a solution of 3.8 g DISPONIL SUS 87 (BASF, a sulfosuccinate fatty alcohol polyglycol ether, disodium salt) and 1.1 g sodium bicarbonate in 183.7 g demineralized water. The mixture was then heated to 85° C. In a separate vessel, a mixture comprising 221.0 g methyl methacrylate (MMA), 230.0 g n-butyl acrylate (BA), and 9.2 g of methacrylic acid (MAA) was emulsified in 190.8 g water in the presence of 11.5 g SIPOMER PAM 600 (BASF, reactive phosphate surfactant), 1.8 g DISPONIL A 3065 (BASF, mixture of ethoxylated linear fatty alcohols), and 9.0 g of a 15 wt. % sodium persulfate aqueous solution was prepared. After 5 minutes, the resulting emulsion was fed to the wax emulsion in the reactor over 4 hours. The combined emulsion was left to polymerize for 60 minutes, after which time the reaction mixture was cooled to 50° C. After cooling to 50° C., 51.0 g of a 1.0 wt. % aqueous solution of t-butyl hydroperoxide and 52.0 g of a 0.8 wt. % aqueous solution of BRUGGOLITE® FF6 reducing agent (Brüggemann, organic sulfinic add sodium salt) were fed to the reactor in parallel over a period of 1 hour. After feeding, the reactor was maintained at 50° C. for 30 minutes and then cooled to room temperature. After cooling, 5.8 g of 25% aqueous ammonia was added slowly and mixed for 15 minutes. Finally, 4.5 g of a 10% biocide solution was combined with the polymer emulsion and stirred for 10 minutes. The polymer emulsion was then used without further modification.

Formation of Polymer Emulsions Lacking Wax Particles (Comparison Experiment). One kilogram of emulsion was prepared by semi-batch emulsion polymerization in a temperature-regulated, double-walled glass reactor, fitted with an overhead condenser, stirrer and nitrogen inlet. The glass reactor was charged with a solution of 3.8 g DISPONIL SUS 87 and 1.1 g sodium bicarbonate in 212.5 g demineralized water. The mixture was then heated to 85° C. In a separate vessel, a mixture comprising 221.0 g MMA, 230.0 g BA, and 9.2 g of methacrylic acid MAA was emulsified in 190.8 g water in the presence of 11.5 g SIPOMER PAM 600, 1.8 g DISPONIL A 3065, and 5.5 g of a 15 wt. % sodium persulfate aqueous solution was prepared. The emulsion was left to polymerize for 60 minutes, after which time the reaction mixture was cooled to 50° C. After cooling to 50° C., 51.0 g of a 1.0 wt. % aqueous solution of t-butyl hydroperoxide and 52.0 g of a 0.8 wt. % aqueous solution of BRUGGOLITE® FF6 reducing agent were fed to the reactor in parallel over a period of 1 hour. After feeding, the reactor was maintained at 50° C. for 30 minutes and then cooled to room temperature. After cooling, 5.8 g of 25% aqueous ammonia was added slowly and mixed for 15 min. Finally, 4.5 g of a 10% biocide solution was combined with the polymer emulsion and stirred for 10 minutes. The polymer emulsion was then used without further modification.

Polymer emulsions containing polymers formed with varying monomer compositions and different wax core particles were synthesized using the above procedure, as specified in Table 1 below. ME52137PE (non-ionic polyethylene emulsion), ME61335 (anionic polyethylene emulsion), ME93335 (non-ionic high-density polyethylene emulsion) and ME24414 (anionic carnauba wax emulsion) are wax emulsions available from Michelman. Comparative samples were prepared by omitting the reactive surfactant and/or the wax emulsion from the synthetic procedure (representative synthesis for wax-free emulsions provided above), as also shown in Table 1 below. The following abbreviations are used in Table 1: HEMA=hydroxethylmethacrylate; BUMA =butyl methacrylate; DAAM =diacetone acrylamide; MAA =methylacrylic acid; MMA =methyl methacrylate; 2-EHA =2-ethylhexylacrylate; UMA=ureidomethacrylate; and BA =butyl acrylate. Monomer weight percentages in Table 1 are measured with respect to the total polymer and sum to 100%. Surfactant and wax particle weight percentages in Table 1 are measured with respect to total solids in the emulsion. For the samples shown in Table 1, particle size evolution, coagulum formation, residual monomers, glass transition temperature (Tg) and core particle incorporation were monitored. Differential scanning calorimetry (DSC) was used to monitor Tg and core particle incorporation. Tg values may be determined using a DSC 3+instrument (Mettler Toledo) and employing a scanning cycle consisting of an initial cooling to −90° C. at a 40° C./min ramp, a stabilizing period of 5 minutes at this temperature, heating at a ramp of 40° C./min up to a temperature of 130° C./min, and a second stabilizing period of 5 minutes at this temperature.

TABLE 1

| | | Polymer | | Surfactant Type | Wax Source |
|---|---|---|---|---|---|
| Sample | Sample | Type | Monomer | (Total Wt. % in | (Wt. % in |
| No. | Type | (Tg, ° C.) | Composition | Emulsion) | Emulsion) |
| 1 | Comp. | High Tg | 13.1% HEMA | Non-reactive | None |
| | | Olefinic 1 | 74.3% BUMA | only | (0%) |
| | | | 6.1% DAAM | (6.8%) | |
| | | | 4.7% MAA | | |
| | | | 1.8% MMA | | |
| 2 | Comp. | High Tg | 13.1% HEMA | Non-reactive | ME52137PE |
| | | Olefinic 1 | 74.3% BUMA | only | (5.3%) |
| | | | 6.1% DAAM | (6.8%) | |
| | | | 4.7% MAA | | |
| | | | 1.8% MMA | | |
| 3 | Comp. | High Tg | 13.1% HEMA | Non-reactive | ME61335 |
| | | Olefinic 1 | 74.3% BUMA | only | (5.1%) |
| | | | 6.1% DAAM | (6.8%) | |
| | | | 4.7% MAA | | |
| | | | 1.8% MMA | | |
| 4 | Comp. | Low Tg | 49.6% MMA | Non-reactive | None |
| | | Olefinic 1 | 48.6% 2-EHA | only | (0%) |
| | | (12.4° C.) | 1.8% MAA | (4.4%) | |
| 5 | Comp. | Low Tg | 49.6% MMA | Non-reactive | ME62330 |
| | | Olefinic 1 | 48.6% 2-EHA | only | (29.0%) |
| | | | 1.8% MAA | (4.4%) | |
| 6 | Comp. | Low Tg | 49.6% MMA | Non-reactive | ME52137PE |
| | | Olefinic 1 | 48.6% 2-EHA | only | (5.1%) |
| | | | 1.8% MAA | (4.4%) | |
| 7 | Comp. | Low Tg | 49.6% MMA | Non-reactive | ME52137PE |
| | | Olefinic 1 | 48.6% 2-EHA | only | (32.0%) |
| | | | 1.8% MAA | (4.4%) | |
| 8 | Comp. | Low Tg | 49.6% MMA | Non-reactive | None |
| | | Olefinic 1 | 48.6% 2-EHA | only | (0%) |
| | | (12.4° C.) | 1.8% MAA | (2.6%) | |
| 9 | Comp. | Low Tg | 49.6% MMA | Non-reactive | ME62330 |
| | | Olefinic 1 | 48.6% 2-EHA | only | (5.0%) |
| | | | 1.8% MAA | (2.6%) | |
| 10 | Comp. | Low Tg | 49.6% MMA | Non-reactive | ME52137PE |
| | | Olefinic 1 | 48.6% 2-EHA | only | (5.2%) |
| | | | 1.8% MAA | (2.6%) | |
| 11 | Comp. | Core-Shell | Core) 42.0% | Non-reactive | None |
| | | (−8.0° C.) | MMA, 25.8% | only | (0%) |
| | | | UMA, 21.0% BA, | (2.8%) | |
| | | | 3.0% DAAM, | | |
| | | | 8.2% MAA | | |
| | | | Shell) 14.3% | | |
| | | | BUMA, 20.4% | | |
| | | | UMA, 63.8% BA, | | |
| | | | 1.5% DAAM | | |
| 12 | Comp. | Core-Shell | Core) 42.0% | Non-reactive | ME93335 |
| | | | MMA, 25.8% | only | (5.3%) |
| | | | UMA, 21.0% BA, | (2.8%) | |
| | | | 3.0% DAAM, | | |
| | | | 8.2% MAA | | |
| | | | Shell) 14.3% | | |
| | | | BUMA, 20.4% | | |
| | | | UMA, 63.8% BA, | | |
| | | | 1.5% DAAM | | |
| 13 | Comp. | Core-Shell | Core) 42.0% | Non-reactive | ME61335 |
| | | | MMA, 25.8% | only | (5.4%) |
| | | | UMA, 21.0% BA, | (2.8%) | |
| | | | 3.0% DAAM, | | |
| | | | 8.2% MAA | | |
| | | | Shell) 14.3% | | |
| | | | BUMA, 20.4% | | |
| | | | UMA, 63.8% BA, | | |
| | | | 1.5% DAAM | | |
| 14 | Comp. | Core-Shell | Core) 42.0% | Non-reactive | ME62330 |
| | | | MMA, 25.8% | only | (5.0%) |
| | | | UMA, 21.0% BA, | (2.8%) | |
| | | | 3.0% DAAM, | | |
| | | | 8.2% MAA | | |
| | | | Shell) 14.3% | | |
| | | | BUMA, 20.4% | | |
| | | | UMA, 63.8% BA, | | |
| | | | 1.5% DAAM | | |
| 15 | Comp. | Core-Shell | Core) 42.0% | Non-reactive | ME24414 |
| | | | MMA, 25.8% | only | (5.1%) |
| | | | UMA, 21.0% BA, | (2.8%) | |
| | | | 3.0% DAAM, | | |
| | | | 8.2% MAA | | |
| | | | Shell) 14.3% | | |
| | | | BUMA, 20.4% | | |
| | | | UMA, 63.8% BA, | | |
| | | | 1.5% DAAM | | |
| 16 | Comp. | Core-Shell | Core) 42.0% | Non-reactive | ME52137PE |
| | | | MMA, 25.8% | only | (4.7%) |
| | | | UMA, 21.0% BA, | (2.8%) | |
| | | | 3.0% DAAM, | | |
| | | | 8.2% MAA | | |
| | | | Shell) 14.3% | | |
| | | | BUMA, 20.4% | | |
| | | | UMA, 63.8% BA, | | |
| | | | 1.5% DAAM | | |
| 17 | Comp. | Low Tg | 48.0% MMA, | Mix of reactive | None |
| | | Olefinic 2 | 50.0% BA, 2.0% | and non- | (0%) |
| | | (22.0° C.) | MAA | reactive | |
| | | | | (2.2%) | |
| 18 | Exp. | Low Tg | 48.0% MMA, | Mix of reactive | ME62330 |
| | | Olefinic 2 | 50.0% BA, 2.0% | and non- | (5.3%) |
| | | (16.8° C.) | MAA | reactive | |
| | | | | (2.2%) | |
| 19 | Exp. | Low Tg | 48.0% MMA, | Mix of reactive | ME52137PE |
| | | Olefinic 2 | 50.0% BA, 2.0% | and non- | (5.0%) |
| | | (21.8° C.) | MAA | reactive | |
| | | | | (2.2%) | |
| 20 | Comp. | Low Tg | 48.0% MMA, | Mix of reactive | None |
| | | Olefinic 2 | 50.0% BA, 2.0% | and non- | (0%) |
| | | (22.0° C.) | MAA | reactive | |
| | | | | (1.9%) | |
| 21 | Exp. | Low Tg | 48.0% MMA, | Mix of reactive | ME62330 |
| | | Olefinic 2 | 50.0% BA, 2.0% | and non- | (5.1%) |
| | | (16.2° C.) | MAA | reactive | |
| | | | | (1.9%) | |
| 22 | Exp. | Low Tg | 48.0% MMA, | Mix of reactive | ME52137PE |
| | | Olefinic 2 | 50.0% BA, 2.0% | and non- | (5.2%) |
| | | (21.0° C.) | MAA | reactive | |
| | | | | (1.9%) | |
| 23 | Comp. | High Tg | 61.5% MMA, | Mix of reactive | None |
| | | Olefinic 2 | 34.5% 2-EHA, | and non- | (0%) |
| | | (50° C.) | 1.5% MAA, 2.5% | reactive | |
| | | | DAAM | (2.0%) | |
| 24 | Exp. | High Tg | 61.5% MMA, | Mix of reactive | ME62330 |
| | | Olefinic 2 | 34.5% 2-EHA, | and non- | (5.3%) |
| | | (50° C.) | 1.5% MAA, 2.5% | reactive | |
| | | | DAAM | (2.0%) | |

Coatings on Glass Substrates. Table 2 below shows testing results for coatings formed from the polymer samples specified in Table 1. Coatings having a 200 μm wet thickness were deposited by casting upon a glass substrate using a stainless steel film applicator. The coatings were dried for 7 days at room temperature before further analysis in accordance with the following. Adhesion was measured on a 0 to 5 numerical ranking scale according to ISO 2409, with 0 representing the best and 5 representing the worst adhesion. Contact angle with water was measured by a sessile drop method in static mode. Whitening resistance was measured by immersion of the coated glass substrates in deionized water for 24 hours and visually determining the color change of the coating. A rating of 1-6 was determined subjectively, with 1 representing the best whitening resistance.

TABLE 2

| Sam- | Sam- | | Wax | Adhe- | Contact | Whitening |
|---|---|---|---|---|---|---|
| ple | ple | Polymer | Source | sion | Angle | Resistance |
| No. | Type | Type | (Wt. %) | (0-5) | (°) | (1-6) |
| 1 | Comp. | High Tg | None | 3 | 71 | 3 |
| | | Olefinic 1 | 0% | | | |
| 2 | Comp. | High Tg | ME52137PE | 5 | 55 | 2 |
| | | Olefinic 1 | (5.3%) | | | |
| 3 | Comp. | High Tg | ME61335 | 5 | 62 | 2 |
| | | Olefinic 1 | (5.1%) | | | |
| 4 | Comp. | Low Tg | None | 2 | 71 | 1 |
| | | Olefinic 1 | (0%) | | | |
| 5 | Comp. | Low Tg | ME62330 | 2 | 86 | 3 |
| | | Olefinic 1 | (29.0%) | | | |
| 6 | Comp. | Low Tg | ME52137PE | 3 | 85 | 3 |
| | | Olefinic 1 | (5.1%) | | | |
| 7 | Comp. | Low Tg | ME52137PE | 5 | 50 | 2 |
| | | Olefinic 1 | (32.0%) | | | |
| 8 | Comp. | Low Tg | None | 1 | 67 | 1 |
| | | Olefinic 1 | (0%) | | | |
| 9 | Comp. | Low Tg | ME62330 | 3 | 88 | 2 |
| | | Olefinic 1 | (5.0%) | | | |
| 10 | Comp. | Low Tg | ME52137PE | 4 | 62 | 2 |
| | | Olefinic 1 | (5.2%) | | | |
| 11 | Comp. | Core-Shell | None | 5 | 83 | 1 |
| | | | (0%) | | | |
| 12 | Comp. | Core-Shell | ME93335 | 3 | 77 | 2 |
| | | | (5.3%) | | | |
| 13 | Comp. | Core-Shell | ME61335 | 2 | 89 | 2 |
| | | | (5.4%) | | | |
| 14 | Comp. | Core-Shell | ME62330 | 1 | 95 | 4 |
| | | | (5.0%) | | | |
| 15 | Comp. | Core-Shell | ME24414 | 2 | 70 | 3 |
| | | | (5.1%) | | | |
| 16 | Comp. | Core-Shell | ME52137PE | 5 | 81 | 2 |
| | | | (4.7%) | | | |
| 17 | Comp. | Low Tg | None | 0 | 82 | 2 |
| | | Olefinic 2 | (0%) | | | |
| 18 | Exp. | Low Tg | ME62330 | 0 | 98 | 2 |
| | | Olefinic 2 | (5.3%) | | | |
| 19 | Exp. | Low Tg | ME52137PE | 0 | 67 | 6 |
| | | Olefinic 2 | (5.0%) | | | |
| 20 | Comp. | Low Tg | None | 0 | 78 | 2 |
| | | Olefinic 2 | (0%) | | | |
| 21 | Exp. | Low Tg | ME62330 | 0 | 97 | 2 |
| | | Olefinic 2 | (5.1%) | | | |
| 22 | Exp. | Low Tg | ME52137PE | 0 | 70 | 2 |
| | | Olefinic 2 | (5.2%) | | | |
| 23 | Comp. | High Tg | None | 0 | 72 | 3 |
| | | Olefinic 2 | (0%) | | | |
| 24 | Exp. | High Tg | ME62330 | 0 | 89 | 5 |
| | | Olefinic 2 | (5.3%) | | | |

Particularly good adhesion was realized for all of the samples incorporating a reactive surfactant. As shown, certain samples formed from a wax emulsion and a reactive surfactant maintained good adhesion and whitening resistance. Samples having a ME62330 core usually were the most hydrophobic among comparable samples, as evidenced by their high contact angle values. It is expected that a similar improvement in adhesion may be realized by incorporating a reactive surfactant during formation of core-shell emulsion particles, particularly during formation of the shell layer.

Raman Spectroscopy Analysis. Migration of the wax within the polymer coating was mapped for Sample 20 mixed with ME62330 wax emulsion and as-prepared Sample 21 after coating each of these samples onto a glass substrate at a 200 μm wet coating thickness. The coatings were first cast upon the glass substrate using a stainless steel film applicator and dried at room temperature for 7 days before further analysis. Mapping of the wax distribution was performed using a Witec Alpha 300 Raman/AFM microscope using confocal imaging at a laser wavelength of 532 nm over a scan range of 1000-3200 cm⁻¹. Raman spectra were collected at five different depths. The change in the wax distribution was determined by comparing the intensity of the wax signals at 2848-2882 cm⁻¹ against the polymer signals at 2936-2948 cm⁻¹ at each depth.

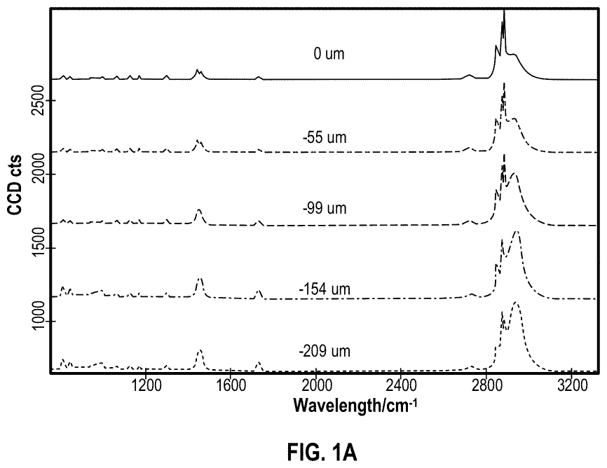

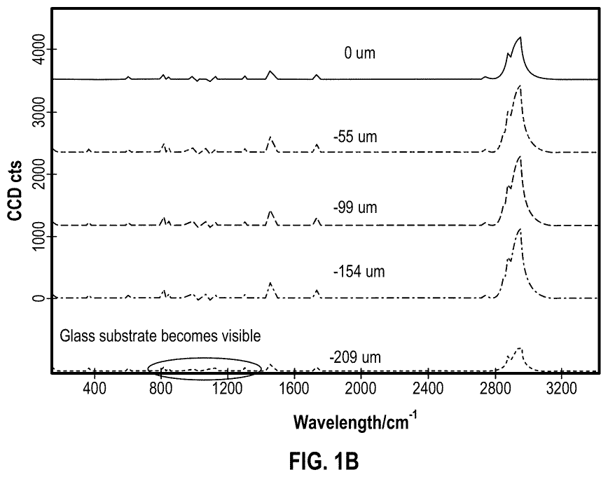

FIG. 1A shows a Raman depth measurement of a polymer coating formed from Sample 20 mixed with a wax particle emulsion, and FIG. 1B shows a Raman depth measurement of a polymer coating formed from Sample 21. In the polymer coating formed from Sample 20, the intensity of the wax peaks decreased with increasing depth within the polymer coating, thereby indicating a non-uniform wax distribution. The wax particle concentration was greater near the coating surface. The polymer coating formed from Sample 21, in contrast, maintained a relatively consistent intensity ratio between the wax peaks and the polymer peaks, thereby indicating a uniform distribution of the wax particles within the polymer coating.

Coatings on Southern Yellow Pine Wood Substrates. Table 3 below shows testing results for certain polymer samples specified in Table 1 when coated on a southern yellow pine wood substrate. Coatings having a 200 μm wet thickness were deposited upon a previously conditioned and cleaned substrate using a stainless steel film applicator. The coatings were dried for 7 days at room temperature before further analysis in accordance with the following. Gloss was measured at a 60° viewing angle using a Glossmeter (ASTM D523). Water beading was measured by placing a few drops of water on the surface of the coated substrate and covering with a watch glass. Droplet absorption was monitored every 30 minutes until complete absorption into the wood occurred.

TABLE 3

| | | | Wax | | Water |
|---|---|---|---|---|---|
| Sample | Sample | Polymer | Source | Gloss at | Beading |
| No. | Type | Type | (Wt. %) | 60º | (hr) |
| 11 | Comp. | Core-Shell | None | 73 | 4 |
| | | | (0%) | | |
| 11a | Comp. | Core-Shell | ME62330 | — | 3 |
| | | | (5.0%) | | |
| 11b | Comp. | Core-Shell | ME24414 | — | 4 |
| | | | (5.1%) | | |
| 14 | Comp. | Core-Shell | ME62330 | 68 | 6 |
| | | | (5.0%) | | |
| 15 | Comp. | Core-Shell | ME24414 | 68 | 4 |
| | | | (5.1%) | | |
| 17 | Comp. | Low Tg | None | 59 | 48 |
| | | Olefinic 2 | (0%) | | |
| 17a | Comp. | Low Tg | ME62330 | — | 34 |
| | | Olefinic 2 | (5.3%) | | |
| 17b | Comp. | Low Tg | ME52137PE | — | 23 |
| | | Olefinic 2 | (5.0%) | | |
| 18 | Exp. | Low Tg | ME62330 | 63 | 51 |
| | | Olefinic 2 | (5.3%) | | |
| 19 | Exp. | Low Tg | ME52137PE | 59 | 28 |
| | | Olefinic 2 | (5.0%) | | |
| 20 | Comp. | Low Tg | None | 53 | 22 |
| | | Olefinic 2 | (0%) | | |
| 20a | Comp. | Low Tg | ME62330 | — | 26 |
| | | Olefinic 2 | (5.1%) | | |
| 20b | Comp. | Low Tg | ME52137PE | — | 27 |
| | | Olefinic 2 | (5.2%) | | |
| 21 | Exp. | Low Tg | ME62330 | 60 | 44 |
| | | Olefinic 2 | (5.1%) | | |
| 22 | Exp. | Low Tg | ME52137PE | 57 | 32 |
| | | Olefinic 2 | (5.2%) | | |

As shown in Table 3, incorporation of the reactive surfactant significantly increased the water beading time. Among the samples containing the reactive surfactant, those having ME62330 as core particles exhibited significantly higher water beading times. The increased water beading times are indicative of a longer time for complete water absorption into the wood substrate to occur. Thus, samples having ME62330 as the core particles afforded the highest water repellency.

Additional comparative samples in Table 3 were prepared by modifying the wax-free comparative samples (Sample Nos. 11, 17 and 20) with an equivalent amount of wax from subsequently run comparative or experimental samples (i.e., Sample. Nos. 14 and 15 for Sample No. 11, Sample Nos. 18 and 19 for Sample No. 17, and Sample Nos. 21 and 22 for Sample No. 20). That is, in the additional comparative samples, the wax emulsion was introduced to the polymer emulsion following polymerization. Introduction of the wax emulsion was conducted by blending the two emulsions under mild agitation at room temperature. Water beading performance of the additional comparative samples was then measured. In the case of the comparative samples lacking a reactive surfactant (Sample Nos. 11a and 11b), the water beading performance was unchanged or modestly poorer than that obtained when the wax was included during the emulsion polymerization. In the case of the comparative samples including the reactive surfactant (Sample Nos. 17a, 17b, 20a and 20b), the water beading performance was significantly decreased in one instance (Sample Nos. 17a and 17b) and modestly increased in the other (Sample Nos. 20a and 20b). In sets of samples containing the reactive surfactant, however, the water beading performance was poorer than that obtained in the corresponding samples including the wax emulsion prior to conducting the emulsion polymerization. This demonstrates the synergy possible by including the wax emulsion during emulsion polymerization in the presence of a reactive surfactant.

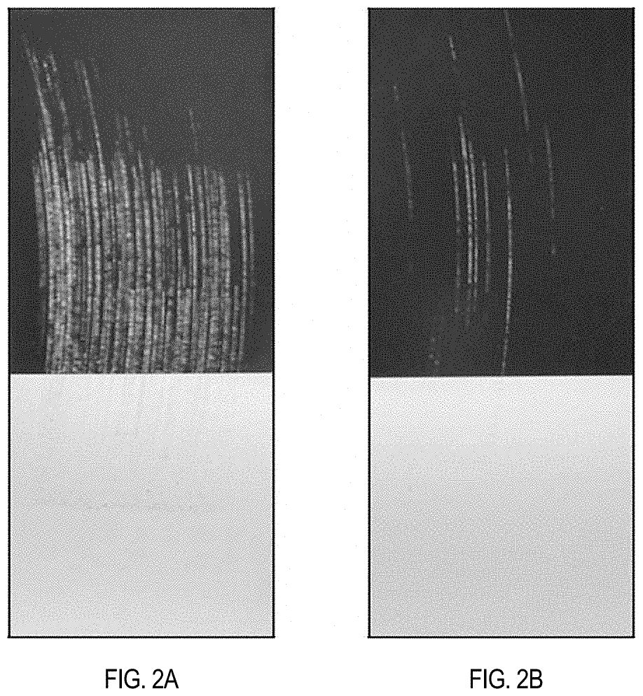

Good dry rub resistance was also realized for the sample containing ME62330 and the reactive surfactant, as shown in the comparative images of FIGS. 2A and 2B (comparison between Samples 17 and 18). Dry rub resistance was determined according to ASTM-D5264 by performing drawdowns on Leneta Charts N2A-2 using a rod #0 and drying the coating for 1 minute at 105° C. Leneta charts were cut at 76 mm by 152 mm in size, placed in a Sutherland instrument with a 4.0 lb receptor block covered in an unprinted sheet of substrate and run for 50 cycles at a time. The number of cycles to damage surface of the Leneta chart was registered. FIG. 2A shows an image of the dry rub resistance of Sample 17, which lacked ME62330 wax core particles. FIG. 2B shows an image of the dry rub resistance of Sample 18, which contained ME62330 wax core particles. Significantly enhanced dry rub resistance was realized for the sample containing the ME62330 wax core particles (up to 200 cycles of resistance). Collectively, the samples containing ME62330 and a reactive surfactant may exhibit improved contact angle, water beading, dirt pickup resistance, color retention, and adhesion.

Coatings on Steel Substrates. The samples containing ME62330 also afforded improved corrosion resistance when deposited upon bare steel substrates. Improved methyl ethyl ketone resistance and hardness were also realized. Corrosion resistance was evaluated using salt spray fog testing according to ASTM B117-03 after 24 hours of exposure. Samples were coated as above using 100 μm and 200 μm wet thicknesses and dried for 7 days at room temperature. At a wet coating thickness of 100 μm, greater flash rust protection was afforded with a coating formed from the sample containing wax core particles compared to coatings lacking the wax core particles. At a wet coating thickness of 200 μm, corrosion protection up to 100 hours was achieved for the sample containing the wax core particles, as compared to only 24 hours for samples lacking the wax core particles.

All documents described herein are incorporated by reference herein for purposes of all jurisdictions where such practice is allowed, including any priority documents and/or testing procedures to the extent they are not inconsistent with this text. As is apparent from the foregoing general description and the specific embodiments, while forms of the disclosure have been illustrated and described, various modifications can be made without departing from the spirit and scope of the disclosure. Accordingly, it is not intended that the disclosure be limited thereby. For example, the compositions described herein may be free of any component, or composition not expressly recited or disclosed herein. Any method may lack any step not recited or disclosed herein. Likewise, the term “comprising” is considered synonymous with the term “including.” Whenever a method, composition, element or group of elements is preceded with the transitional phrase “comprising,” it is understood that we also contemplate the same composition or group of elements with transitional phrases “consisting essentially of,” “consisting of,” “selected from the group of consisting of,” or “is” preceding the recitation of the composition, element, or elements and vice versa.

Unless otherwise indicated, all numbers expressing quantities of ingredients, properties such as molecular weight, reaction conditions, and so forth used in the present specification and associated claims are to be understood as being modified in all instances by the term “about.” Accordingly, unless indicated to the contrary, the numerical parameters set forth in the following specification and attached claims are approximations that may vary depending upon the desired properties sought to be obtained by the embodiments of the present invention. At the very least, and not as an attempt to limit the application of the doctrine of equivalents to the scope of the claim, each numerical parameter should at least be construed in light of the number of reported significant digits and by applying ordinary rounding techniques.

Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the elements that it introduces.

One or more illustrative embodiments are presented herein. Not all features of a physical implementation are described or shown in this application for the sake of clarity. It is understood that in the development of a physical embodiment of the present disclosure, numerous implementation-specific decisions must be made to achieve the developer's goals, such as compliance with system-related, business-related, government-related and other constraints, which vary by implementation and from time to time. While a developer's efforts might be time-consuming, such efforts would be, nevertheless, a routine undertaking for one of ordinary skill in the art and having benefit of this disclosure.

Therefore, the present disclosure is well adapted to attain the ends and advantages mentioned as well as those that are inherent therein. The particular embodiments disclosed above are illustrative only, as the present disclosure may be modified and practiced in different but equivalent manners apparent to one having ordinary skill in the art and having the benefit of the teachings herein. Furthermore, no limitations are intended to the details of construction or design herein shown, other than as described in the claims below. It is therefore evident that the particular illustrative embodiments disclosed above may be altered, combined, or modified and all such variations are considered within the scope and spirit of the present disclosure. The embodiments illustratively disclosed herein suitably may be practiced in the absence of any element that is not specifically disclosed herein and/or any optional element disclosed herein.

1. A polymer emulsion comprising:
an aqueous fluid;
a plurality of core particles;
a polymer layer formed around at least a majority of the plurality of core particles, the polymer layer comprising a polymer formed from one or more ethylenically unsaturated monomers;
wherein the polymer layer is substantially uniform in composition; and
one or more surfactants;
wherein the one or more surfactants comprise at least one reactive surfactant having an ethylenic unsaturation that is covalently incorporated within the polymer; and
wherein the at least one reactive surfactant is absent from the core particles when the polymer layer is formed thereon.

2. The polymer emulsion of claim 1, wherein the at least one reactive surfactant comprises an anionic surfactant.

3. (canceled)

4. The polymer emulsion of claim 1, wherein the plurality of core particles comprises wax particles.

5. (canceled)

6. The polymer emulsion of claim 1, wherein the plurality of core particles have an average diameter about 100 nm or less.

7. The polymer emulsion of claim 1, wherein the polymer comprises at least one acrylate monomer.

8. The polymer emulsion of claim 1, wherein the one or more surfactants further comprise at least one non-reactive surfactant.

9. The polymer emulsion of claim 8, wherein the at least one reactive surfactant comprises a majority of the one or more surfactants on a weight basis.

10. (canceled)

11. The polymer emulsion of claim 1, wherein the one or more surfactants are present in an amount ranging from about 0.2 wt. % to about 7.0 wt. %, as measured based on total solids, and the at least one reactive surfactant is present in an amount ranging from about 0.2 wt. % to about 5 wt. %, as measured based on total solids.

12. (canceled)

13. (canceled)

14. (canceled)

15. A coated substrate comprising:
a base substrate; and
a polymer coating disposed upon a surface of the base substrate, the polymer coating being formed from the polymer emulsion of claim 1.

16. (canceled)

17. (canceled)

18. The coated substrate of claim 15, wherein the polymer is crosslinked within the polymer coating.

19. A method comprising:
providing a core particle emulsion comprising a first aqueous fluid, a plurality of core particles, and a first surfactant;
combining one or more ethylenically unsaturated monomers and at least one reactive surfactant having an ethylenic unsaturation with the core particle emulsion to form a combined emulsion; and
polymerizing the one or more ethylenically unsaturated monomers and the at least one reactive surfactant to form a polymer emulsion comprising a plurality of emulsified particles comprising a polymer layer formed around at least a majority of the plurality of core particles, the at least one reactive surfactant being covalently incorporated within a polymer comprising the polymer layer;
wherein the polymer layer is substantially uniform in composition, and the at least one reactive surfactant is absent from the core particles when the polymer layer is formed thereon.

20. The method of claim 19, wherein the one or more ethylenically unsaturated monomers and the at least one reactive surfactant are present in a monomer emulsion comprising a second aqueous fluid that is combined with the core particle emulsion.

21. The method of claim 19, wherein polymerizing takes place thermally in the presence of a first radical initiator.

22. The method of claim 21, further comprising:
conducting further polymerization under reductive conditions.

23. The method of claim 19, wherein the at least one reactive surfactant comprises an anionic surfactant.

24. (canceled)

25. The method of claim 19, wherein the one or more surfactants further comprise at least one non-reactive surfactant.

26. The method of claim 25, wherein the at least one reactive surfactant comprises a majority of the one or more surfactants on a weight basis.

27. (canceled)

28. The method of claim 19, wherein the one or more surfactants are present in the combined emulsion in an amount ranging from about 0.2 wt. % to about 7.0 wt. %, as measured based on total solids, and the at least one reactive surfactant is present in the combined emulsion in an amount ranging from about 0.2 wt. % to about 5 wt. %, as measured based on total solids.

29. (canceled)

30. (canceled)

31. The method of claim 19, wherein the plurality of core particles comprises wax particles.

32. (canceled)

33. The method of claim 19, wherein the plurality of core particles have an average diameter about 100 nm or less.

34. The method of claim 19, wherein the polymer comprises at least one acrylate monomer.

35. (canceled)

36. (canceled)

37. (canceled)
